(19) United States
(12) Patent Application Publication
(10) Pub. No.: US 2007/0298377 A1
(43) Pub. Date: Dec. 27, 2007

(54) Deposition of silver particles on an implant surface

(75) Inventors: James Kenealy, Hobe Sound, FL (US); Bruce Berckmans, Palm Beach Gardens, FL (US); T. Tait Robb, Stewart, FL (US)

Correspondence Address: NIXON PEABODY, LLP, 161 N. CLARK ST., 48TH FLOOR, CHICAGO, IL, 60601-3213, US

(73) Assignee: Biomet 3i, Inc.

(21) Appl. No.: 11/820,831

(22) Filed: Jun. 21, 2007

Related U.S. Application Data
(60) Provisional application No. 60/815,901, filed on Jun. 22, 2006.

(51) Int. Cl. A61C 8/00

(52) U.S. Cl. 433/173; 433/201.1

(57) ABSTRACT

A dental implant assembly is disclosed. The dental implant assembly comprises an implant. The dental implant assembly further comprises an abutment coupled to a top portion of the implant. The dental implant assembly further comprises a screw for securing the abutment to the implant. The dental implant assembly further comprises silver nanoparticles positioned on at least one interior surface of at least one of the implant and the abutment.

### CROSS-REFERENCE TO RELATED APPLICATION

This application claims the benefit of U.S. Provisional Application No. 60/815,901, filed Jun. 22, 2006, which is incorporated by reference in its entirety.

### FIELD OF THE INVENTION

This invention relates generally to implants and, in particular, to a dental implant having nanoparticles of silver or silver alloy deposited thereon and methods of making the same.

### BACKGROUND OF THE INVENTION

It is becoming more common to replace a missing tooth with a prosthetic tooth that is placed upon and attached to a dental implant assembly. Often, the prosthetic tooth is placed upon or over an abutment, which is attached to an implant of the implant assembly. The implant serves as the artificial root that integrates with the bone tissue of the mouth. The prosthetic tooth preferably has a size and color that mimics the missing natural tooth. Consequently, the patient has an aesthetically pleasing and structurally sound artificial tooth.

One current surgical protocol by which implants are integrated into the patient involves two stages. In the first stage, the implant is inserted into the jawbone, covered by suturing the overlying gingival tissue, and allowed to osseointegrate for a period of two to four months. Covering the implant with the overlying gingiva minimizes the likelihood of infection around the implant and is believed to guard against disturbances that may slow its rate of osseointegration. The implants used in the two stage protocol are sometimes referred to as “subgingival implants.”

After osseointegration is complete, the second stage is encountered in which the gingiva is again cut open and a gingival healing abutment is placed onto the implant. The overlying gingiva is sutured to allow it to properly heal around the healing abutment. When the healing abutment is removed and the prosthetic tooth is placed on the implant, the gingiva nicely conforms around the prosthetic tooth.

Another implant surgical protocol requires one stage and uses an implant called a “transgingival implant” or “single-stage implant” that simultaneously promotes osseointegration and healing of the gingiva. This is accomplished by providing an implant that has a portion that integrates with the jawbone and an abutment portion that extends through the overlying gingiva so that the gingiva properly heals therearound.

While it is desirable that a generally sealed, leak-proof interface exist between the implant and the abutment, the interface always has a small gap (herein referred to as a “microgap”), which may open slightly over time. The microgap typically occurs at the interface between the opposed surfaces of the implant and the abutment. Oral fluids, small food particles, combinations thereof, or the like may gain access to the interior of the implant assembly by passing through the microgap. Capillary action may play a part in the passage of these fluids through the microgap. The oral fluids, food particles, combinations thereof, or the like may contain bacteria and/or nutrients required for bacterial growth, thus promoting the growth and/or spread of bacteria within and around the microgap. The bacterial activity may result in the breakdown of proteins and the production of foul smelling compounds, thereby causing malodor. Furthermore, the presence of bacteria in the microgap may cause or contribute to infection and/or inflammation of the gingival area surrounding the implant.

Ionic silver is highly antimicrobial and, therefore, has an ability to attack and destroy bacteria and/or microbes. Ionic silver is also antimicrobial in extremely low doses (e.g., 0.001 ppm) and is nontoxic to human cells at these low doses. However, because infection of a dental implant site in a conventional sense has been relatively infrequent, silver is typically not used in the dental industry.

The present invention is directed to an improved dental implant assembly that assists in addressing one or more of the above disadvantages.

### SUMMARY OF THE INVENTION

According to one embodiment of the present invention, a dental implant assembly is disclosed. The dental implant assembly comprises an implant. The dental implant assembly further comprises an abutment coupled to a top portion of the implant. The dental implant assembly further comprises a screw for securing the abutment to the implant. The dental implant assembly further comprises silver nanoparticles positioned on at least one interior surface of at least one of the implant and the abutment.

According to another embodiment of the present invention, a method of inhibiting the growth of bacteria or microbes within a dental implant assembly to be implanted into living bone is disclosed. The method comprises the act of providing an implant, an abutment, and a screw. At least a portion of the implant, the abutment, or the screw has silver nanoparticles applied thereto. The method further comprises securing the implant to the abutment using the screw.

According to another embodiment of the present invention, a method of inhibiting the growth of bacteria or microbes within a dental implant assembly is disclosed. The method comprises the act of providing a dental implant assembly. The method further comprises the act of applying silver particles on at least a portion of the dental implant assembly.

The above summary of the present invention is not intended to represent each embodiment, or every aspect, of the present invention. This is the purpose of the figures and the detailed description which follow.

### BRIEF DESCRIPTION OF THE DRAWINGS

The foregoing and other advantages of the invention will become apparent upon reading the following detailed description and upon reference to the drawings.

FIG. 1a is a side view of a dental implant assembly according to one embodiment.

FIG. 1b is an exploded side view of the implant assembly of FIG. 1a.

FIG. 1c is a gingival end view of an implant of the implant assembly of FIGS. 1a and 1b.

FIG. 2a is a side view of a dental implant assembly according to another embodiment.

FIG. 2b is an exploded side view of the implant assembly of FIG. 2a.

FIG. 3 is an exploded side view of the implant of FIGS. 1a-c with having silver nanoparticles deposited thereon, according to one embodiment of the present invention.

FIG. 4 is a flow diagram detailing a method of forming an implant according to one embodiment of the present invention.

### DETAILED DESCRIPTION

The present invention is directed to dental implants having silver nanoparticles deposited thereon and methods of making the same. “Silver,” as used herein, should be understood to describe substantially pure silver or a silver alloy. An implant in the context of the present invention means a device intended to serve as a fixture for a body part (e.g., a fixture for an artificial tooth).

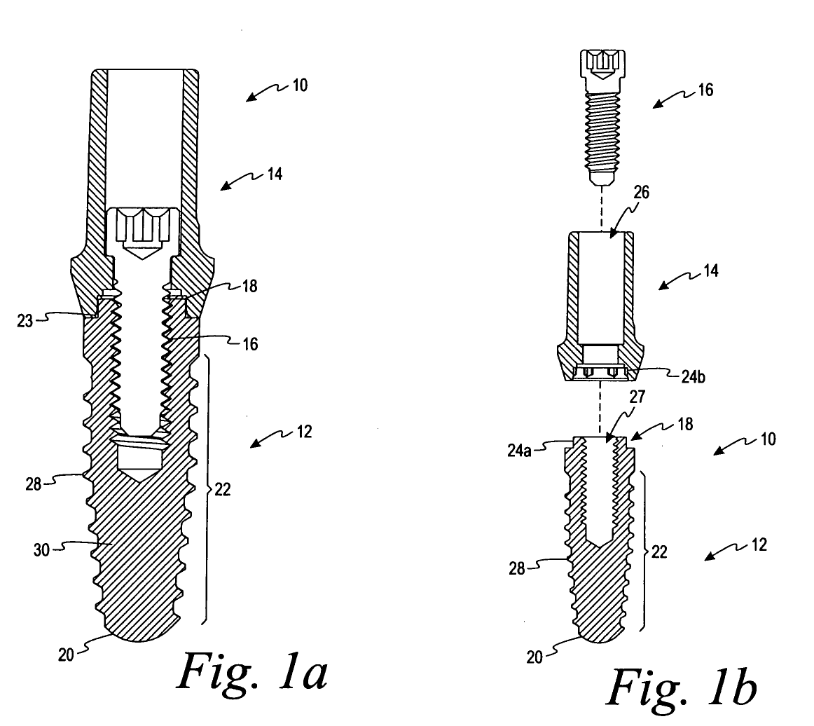

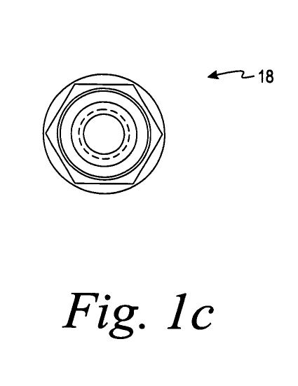

FIGS. 1a-c show a standard dental implant assembly 10 that includes an implant 12, an abutment 14, and a screw 16. The implant 12 generally includes a head portion 18, a lowermost end 20, and a threaded portion 22. The implant 12 may, for example, be made of titanium, tantalum, cobalt, chromium, stainless steel, or alloys thereof. It is contemplated that other materials including, but not limited to, ceramics or ceramic-titanium combinations may also be used.

The implant 12 and the abutment 14 generally meet at an interface 23, which defines a microgap. The implant 12 of the implant assembly 10 of FIGS. 1a-c includes an external feature for non-rotationally engaging a correspondingly shaped, internal feature on the abutment portion 14. This may be referred to as an external connection between the implant 12 and the abutment 14. In the embodiment shown, the non-rotational features include a polygonal boss 24a located on the implant 12 and a polygonal socket 24b located on the abutment portion 14. The polygonal boss 24a and the polygonal socket 24b may, for example, be hexagonal, as shown in the illustrated embodiment of FIG. 1c. The non-rotational features may also be other suitable non-round shapes. The screw 16 extends through a top opening 26 of the abutment 14 and into a cavity 27 located within the implant 12, thereby axially securing the implant 12 to the abutment 14.

The exterior of the threaded portion 22 facilitates bonding with bone or gingiva. The threaded portion 22 includes a thread 28 that makes a plurality of turns around the implant 12. One example of a type of thread structure is described in detail in U.S. Pat. No. 5,902,109, entitled “Reduced Friction, Screw-Type Dental Implant,” which is incorporated by reference in its entirety. The threaded portion 22 may further include a self-tapping region with incremental cutting edges 30 that allows the implant 12 to be installed without the need for a bone tap. These incremental cutting edges 30 are described in detail in U.S. Pat. No. 5,727,943, entitled “Self-Tapping, Screw-Type Dental Implant,” which is incorporated by reference in its entirety.

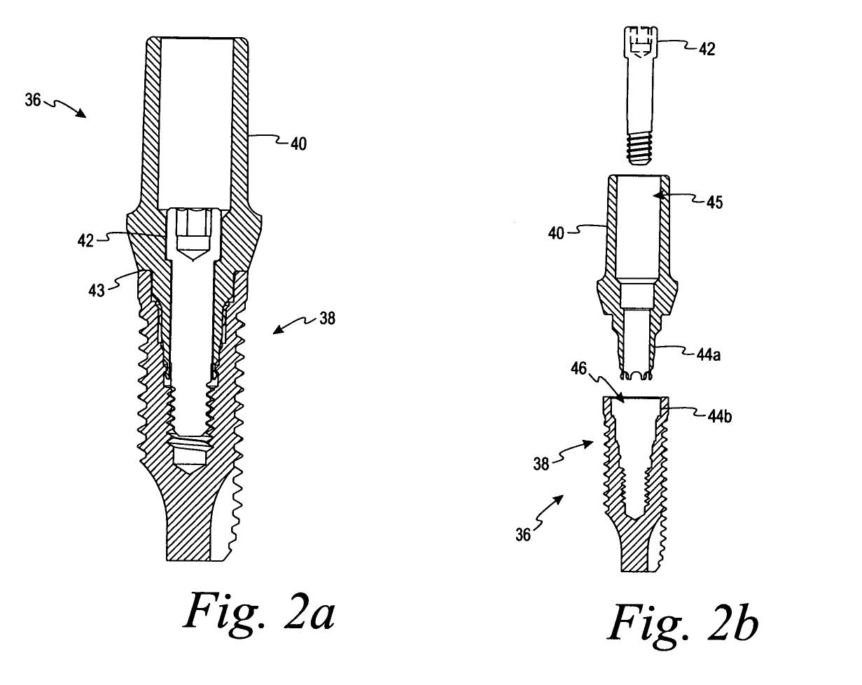

FIGS. 2a,b disclose a dental implant assembly 36 according to another embodiment. The implant assembly 36 includes an implant 38, an abutment 40, and a screw 42. The implant 38 and the abutment 40 have generally flat surfaces that engage to form an interface 43, which defines a microgap. The implant assembly 36 differs from the implant assembly 10 of FIGS. 1a-c in the configuration and locations of the non-rotational features. For example, the implant 38 includes an internal feature for non-rotationally engaging a correspondingly shaped, external feature on the abutment 40. In the embodiment shown, the non-rotational features include a polygonal boss 44a located on the abutment 40 and a polygonal socket 44b located on the implant 38. Such a configuration may be referred to as an internal connection. The polygonal boss 44a and the polygonal socket 44b may be hexagonal or other suitable shapes. The abutment 40 is secured to the implant 38 using the screw 42 that extends through a top opening 45 of the abutment 14 and into a cavity 46 located within the implant 38. It is contemplated that other types of implants and implant assemblies not shown in the illustrated embodiments may also be used with the present invention.

According to the present invention, metallic silver nanoparticles are applied to certain surfaces of the implant assembly 10, 36. In one preferred embodiment, the silver nanoparticles may generally range from about 1 nm to about 50 nm, although particles of greater sizes may be used as well. As the metallic silver nanoparticles come into contact with moisture (e.g., saliva in a patient's mouth), a chemical reaction occurs, thereby producing ionic silver (Ag⁺), a known antimicrobial. Because the size of the silver particles is on the order of nanometers, the surface area available for the chemical reaction to occur is greater (relative to a flat surface). Thus, the number of silver ions produced is increased, thereby enhancing the antimicrobial effect. The presence of the silver nanoparticles may inhibit or prevent the growth and/or spread of bacteria and/or microbes in and/or around the implant assembly. Furthermore, the small size of the nanoparticles will not inhibit the structural integrity of the mating features (e.g., polygonal socket and polygonal boss) or increase the size of the microgap.

Because bacteria-containing oral fluids, small food particles, combinations thereof, or the like may leak into interior apertures or “microgaps” between components of the implant assembly 10, 36, it is desirable for the silver nanoparticles to be applied to interior surfaces of the implant assembly. Referring to FIG. 1b, for example, in addition to the microgap at the surface defining the interfaces 23 and 43, a microgap may exist between the screw 16 and the walls of the cavity 27 of the implant 12. Additionally, a microgap may exist between the non-rotational mating surfaces, such as the surfaces forming the polygonal boss 24a and the polygonal socket 24b. Bacteria may also leak into other parts of the implant assembly 10 including, for example, the top opening 26 of the abutment 14. Thus, it may be desirable that the silver nanoparticles be applied to interior surfaces of the implant 12, 38 and the abutment 14, 20 that define a microgap.

The silver nanoparticles may be applied using any suitable technique. For example, a coating of silver nanoparticles may be applied to an implant surface using techniques including, but not limited to plasma-sputtering or plasma-spraying. It is also contemplated that discrete nanoparticles of silver may be discontinuously deposited onto the surface of the implant component(s).

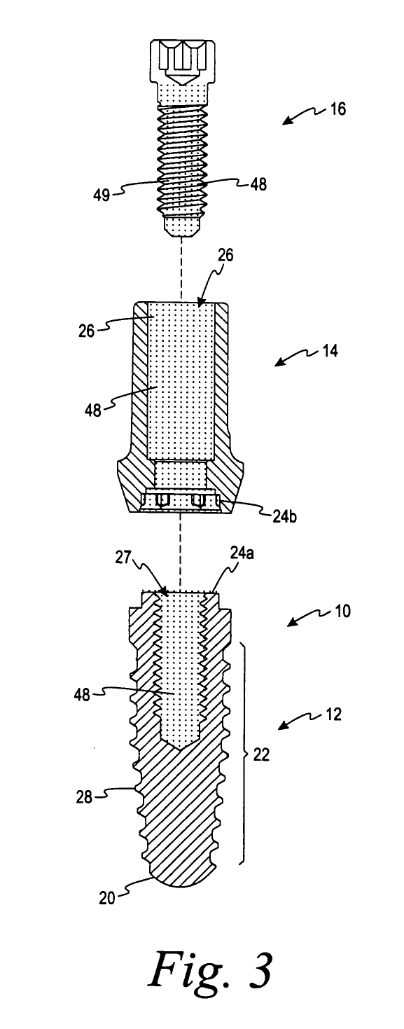

FIG. 3, for example, illustrates the implant assembly 10 of FIGS. 1a-c having silver nanoparticles 48 applied to certain interior surfaces of the implant assembly 10, including the implant 12 and/or the abutment 14. Specifically, the implant assembly 10 includes silver nanoparticles located on an interior surface 49 of the screw 16, the top opening 26 of the abutment 14, the polygonal boss 24a of the implant 12, the polygonal socket 24b of the abutment 14, and the cavity 27 of the implant 12. Further, the flat mating surfaces of the abutment 14 and the implant 12 define the interface 23 (FIG. 1a). Although the illustrated embodiment depicts all of the interior surfaces of the implant assembly 10 having silver nanoparticles deposited thereon, it is contemplated that a single interior surface or any combination(s) thereof may have silver nanoparticles deposited thereon.

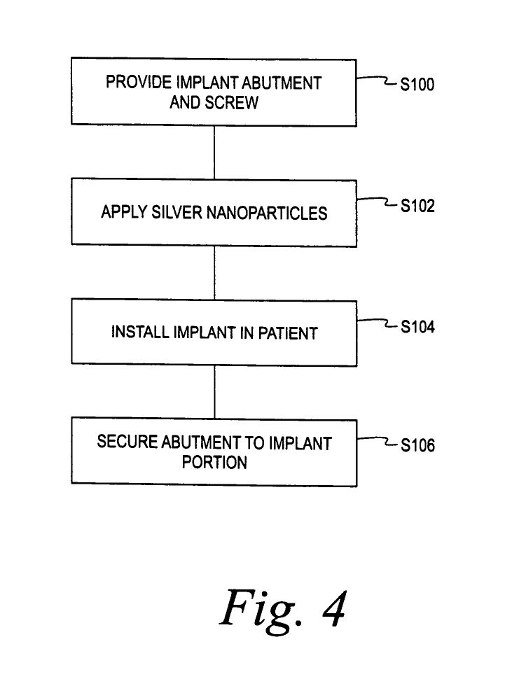

Turning now to FIG. 4, a general method of forming a dental implant assembly is set forth according to one embodiment of the present invention. At step s100, an implant, an abutment, and a screw are provided. Silver nanoparticles are applied to at least a portion of the implant 12, the abutment 14, the screw 16, or a combination thereof at step s102. The implant assembly 10 is then installed in the patient at step s104. The implant 12 is then secured to the abutment 14 using the screw 16 at step s106.

Referring back to FIGS. 1a, 1b, the threads 28 of the implant 12 of the implant assembly 10 used with the present invention may also be etched to remove a native oxide layer from the surface of the implant 12. The surface then becomes roughened, forming a substantially uniform array of microscale irregularities that facilitates bonding with bone. One type of roughening method, which may be used for commercially pure titanium implants, is described in detail in U.S. Pat. No. 5,876,453, entitled “Implant Surface Preparation,” which is incorporated by reference in its entirety. Another type of roughening method, which may be used for titanium alloy implants, is described in detail in U.S. Pat. App. Pub. No. 2004/026570, which is incorporated by reference in its entirety.

The implants used with the present invention may include a material that promotes osseointegration between the implant and bone material (e.g., human bone material). One non-limiting example of a suitable material is a calcium phosphate material, such as hydroxyapatite (HA). In one embodiment, the material includes crystals of HA having dimensions generally ranging from about 10 nanometers to about 150 nanometers.

It is contemplated that the present invention may also be used to inhibit or prevent bone tissue degradation associated with dental implant assemblies 10, 36. When an artificial tooth of a dental implant assembly is used to chew food (mastication), the implant assembly is subject to significant forces that place loads on the abutment. These forces may cause a microgap located at the interface of the abutment and the implant to contract. The contraction of the microgap may force oral fluids and/or food particles containing bacteria to seep out from the microgap and/or interior apertures in the implant assembly and onto the gingival surface. The bacteria contained therein may harm the gingival surface by, for example, causing or contributing to bone tissue degradation. Thus, in addition to inhibiting or preventing malodor, the present invention may also assist in preventing or inhibiting bone tissue degradation.

While the present invention has been generally described relative to interior portions of the implant assembly, it is contemplated that the acts depositing nanoparticles of silver herein described may be performed on the surface of the entire implant component or on the entire implant assembly. Further, depositing the silver to achieve a layer of silver particles across the entire surface or surfaces is also within the scope of the present invention.

While the present invention has been described with reference to one or more particular embodiments, those skilled in the art will recognize that many changes may be made thereto without departing from the spirit and scope of the present invention. Each of these embodiments and obvious variations thereof is contemplated as falling within the spirit and scope of the claimed invention, which is set forth in the following claims.

What is claimed is:

1. A dental implant assembly comprising:
an implant;
an abutment coupled to a top portion of the implant;
a screw for securing the abutment to the implant; and
silver nanoparticles positioned on at least one interior surface of at least one of the implant and the abutment.

2. The implant assembly of claim 1, wherein the implant is made of a metal selected from the group consisting of tantalum, cobalt, chromium, titanium, stainless steel, or alloys thereof.

3. The implant assembly of claim 1, wherein the implant is made from a material including ceramic.

4. The implant assembly of claim 1, wherein the silver nanoparticles are positioned on the screw.

5. The implant assembly of claim 1, wherein at least a portion of a threaded bottom portion is roughened to form irregularities to facilitate bonding with bone.

6. The implant assembly of claim 1, wherein the implant includes a first non-rotational feature and the abutment includes a second non-rotational feature, wherein the first non-rotational feature is adapted to mate with the second non-rotational feature, the silver nanoparticles being located on a surface of at least one of the first and second non-rotational features.

7. The implant assembly of claim 1, wherein the silver nanoparticles are positioned on opposing surfaces of the implant and the abutment that define an interface.

8. The implant assembly of claim 1, wherein the silver nanoparticles have dimensions of about 1 nanometer to about 50 nanometers.

9. The implant assembly of claim 1, wherein the silver nanoparticles are applied on an exterior surface of the screw, an aperture in the abutment for receiving the screw, an aperture in the implant for receiving the screw, or a combination thereof.

10. A method of inhibiting the growth of bacteria or microbes within a dental implant assembly to be implanted into living bone, the method comprising the acts of:
providing an implant, an abutment, and a screw, at least a portion of the implant, the abutment, or the screw having silver nanoparticles applied thereto; and
securing the implant to the abutment using the screw.

11. The method of claim 10, wherein the implant is made of a metal selected from the group consisting of tantalum, cobalt, chromium, titanium, stainless steel, or alloys thereof.

12. The method of claim 10, wherein the implant is made from a material including ceramic.

13. The method of claim 10, wherein the act of providing an implant includes roughening a threaded bottom portion of the implant to facilitate bonding with bone.

14. The method of claim 13, wherein the implant is made of titanium and the act of roughening the implant surface comprises:
removing a native oxide layer from the implant surface; and
acid etching the resulting surface.

15. The method of claim 10, wherein the implant includes a first non-rotational feature and the abutment has a second non-rotational feature, at least one of the first and second non-rotational features having silver nanoparticles applied thereon.

16. The method of claim 15, further comprising the act of, prior to securing the implant to the abutment using the screw, mating the first non-rotational feature with the second non-rotational feature.

17. The method of claim 10, wherein the act of applying the silver nanoparticles includes plasma-spraying or plasma-sputtering.

18. The method of claim 10, wherein the silver nanoparticles are applied on opposing surfaces of the implant and the abutment, the opposing surfaces defining an interface.

19. The method of claim 10, wherein the silver nanoparticles are applied on an interior surface of the screw, an aperture in the abutment for receiving the screw, an aperture in the implant for receiving the screw, or a combination thereof.

20. A method of inhibiting the growth of bacteria or microbes within a dental implant assembly, the method comprising the acts of:
providing a dental implant assembly; and
applying silver particles on at least a portion of the dental implant assembly.

21. The method of claim 20, wherein the implant assembly includes an implant, an abutment, and a screw.

22. The method of claim 21, wherein the implant is made of a metal selected from the group consisting of tantalum, cobalt, chromium, titanium, stainless steel, or alloys thereof.

23. The method of claim 21, wherein the implant is made from a material including ceramic.

24. The method of claim 21, wherein the silver particles are silver nanoparticles.

25. The method of claim 24, wherein the implant includes a first non-rotational feature and the abutment has a second non-rotational feature, wherein at least one of the first and second non-rotational features includes silver nanoparticles applied thereon.

26. The method of claim 24, wherein the silver nanoparticles are applied on opposing surfaces of the implant and the abutment, the opposing surfaces defining an interface.

27. The method of claim 24, wherein the silver nanoparticles are applied on an exterior surface of the screw, an aperture in the abutment for receiving the screw, an aperture in the implant for receiving the screw, or a combination thereof.

28. The method of claim 24, wherein the act of applying the silver nanoparticles includes plasma-spraying or plasma-sputtering.

29. The method of claim 24, wherein the act of applying silver nanoparticles on at least a portion of the dental implant assembly includes forming a layer of silver nanoparticles.

30. The method of claim 24, wherein the silver nanoparticles are applied to an exterior surface of the implant, the abutment, or a combination thereof.

31. The method of claim 30, wherein the exterior surface is adjacent to an interface between the implant and the abutment.
